(19) United States
(12) Patent Application Publication
(10) Pub. No.: US 2008/0172235 A1
(43) Pub. Date: Jul. 17, 2008

(54) VOICE OUTPUT DEVICE AND METHOD FOR SPOKEN TEXT GENERATION

(76) Inventors: Hans Kintzig, Tiefenthal (DE); Ulrich Porsch, Weinheim (DE); Christian Blatt, Neckarsteinach (DE)

Correspondence Address: ROCHE DIAGNOSTICS OPERATIONS INC., 9115 Hague Road, Indianapolis, IN, 46250-0457, US

(21) Appl. No.: 11/953,344

(22) Filed: Dec. 10, 2007

(30) Foreign Application Priority Data
Dec. 13, 2006 (EP) 06025798.7

(51) Int. Cl. G10L 15/00

(52) U.S. Cl. 704/275; 704/E15.018

(57) ABSTRACT

Embodiments are described for a voice output device having a first memory unit configured to store a plurality of audio files, a computation unit configured to associate one or more of the audio files stored in the first memory unit with one or more outputtable data records in the correct order, and an output unit having an audio data output interface for reproducing the audio files in the order prescribed by the computation unit, where the audio files comprise fixed audio files, which contain predetermined sentence components, and variable audio files, which are used to selectively supplement the fixed audio files in order to produce modularly complete sentences.

### PRIORITY CLAIM

The present application is based on and claims the priority of European Patent Application No. 06 025 798.7, filed Dec. 13, 2006, which is hereby incorporated by reference in its entirety.

### TECHNICAL FIELD OF THE INVENTION

The present invention relates to a voice output device and a method for spoken text generation. In particular, the present invention relates to a voice output device for audio output of medically relevant data and to a method for spoken text generation of sentences and/or numbers for the operation of such a voice output device.

### BACKGROUND

In the medical field, it is known practice to use portable medical devices to collect patient data. Frequently, these portable devices are connected to central data processing devices in which monitoring, selection, analysis etc. of the data is performed either by medical personnel, doctors or else automatically. Such devices are used, inter alia, to collect and monitor blood sugar values from diabetics. By way of example, EP 1 559 364 A1 discloses a wireless diabetes monitoring system in which, after transmitting his blood sugar values to a central station, the patient is notified of behavioural instructions via a mobile telephone. Another comparable system is known from US 2005/0089150 A1, in which the telephone and portable devices are used for interactively instructing a user/patient using voice recognition systems and software-generated instructions to the user.

People suffering front diabetes mellitus have to strive to keep their blood sugar value within a particular range at all times. If the desired range is exceeded, insulin needs to be injected. If the desired range is undershot, sugar needs to be administered orally (by means of food or a drink). It the desired range is exceeded over a relatively long time, there is the risk of serious health complications, such as blindness, kidney damage, mortification of limbs or neuropathy. If the range is exceeded significantly for a short time, this may result in nausea, dizziness, sweating and even states of confusion. If the desired range is undershot significantly for a short time, this may likewise result in nausea, dizziness, sweating, confusion and—in the worst case—the death of the diabetic. It is therefore absolutely imperative for a diabetic to know the generally status of his blood sugar at all times and if necessary to be able to initiate suitable measures independently in order to prevent the blood sugar value from breaking out of the desired range. To this end, blood sugar measuring devices have already been used for some time, such as are known from DE 10 2004 057 503 A1 and sold by the applicant under the registered trade mark ACCU-CHEK®. Ideally, the diabetic handles measurement of the blood sugar value and the measurement results himself.

The blood sugar value is subject to severe fluctuations on the basis of the insulin administrations (normally, insulins with different actions are used simultaneously), the quantities of sugar administered and other food, beverages and tobacco having a physiological affect on glycometabolism. Glycometabolism is likewise affected by physical movement, stress, illness and much more. Since not every organism reacts to these physiological variables in the same way, every diabetic needs to get to know his own physiological reactions. Keeping a diabetes diary is essential for this. From the entries in a written diary of this kind, the diabetic can look for similar situations in the history of his entries and compare them with the current situation so as then to initiate appropriate measures to adjust the metabolism. The records allow him to repeat successful adjustments to the metabolism or to make appropriate adjustments to the control elements in order to adjust the physiological situations better than in the past if an adjustment in a similar situation did not result in the desired success. As already stated, this means that it is absolutely necessary for every diabetic to keep such a diary to note down all the parameters or control elements for the metabolism control loop.

A large number of diabetics are affected by blindness. Approximately 80% of all blind diabetics are blind because of their illness, i.e. the blood sugar of these people was not correct over a relatively long time, causing the blindness. Their blindness means that these diabetics are prohibited from keeping a diary (as described above) themselves, and they should not be able to perform insulin therapy independently. Although it is possible for other people to care for them, empirical data show that in such cases the patient's blood sugar adjustment is poorer than when the blood sugar is adjusted on his own account. i.e. adjusting the blood sugar on one's own account reduces the risk of further health complications.

It is therefore very important for the group of blind diabetics to be able to keep a diary themselves and to be able to select the history recorded therein in the form of data in order to initiate suitable measures in critical situations. A parallel patent application to this disclosure, EP 07 002 063, proposes a voice output device which allows blind diabetics to handle their diary data in this manner.

When generating the spoken texts which are to be audibly output by the voice output device, both words and sentence phrases and also numbers need to be produced. This is done on the basis of the files which contain the data records to be output in the voice output device. In principle, it is possible to distinguish between two types of audible output, namely voice synthesis, in which voice elements are formed synthetically, on the one hand, and mere reproduction of voice files with recorded (“genuine”) voice patterns, on the other hand.

Methods for voice generation are generally known. See, for example, U.S. Pat. Nos. 4,727,310; 4,338,490; and 4,707,794, which are each hereby incorporated herein by reference in their entireties.

Generally, several basic requirements should be taken into account for voice generation. For example, the spoken text should sound as natural and continuous (that is to say not chopped off) as possible. In particular, numbers should be output in the usual manner of speaking (that is to say “165” as “one hundred and sixty-five” and not as “one six five”. Another basic requirement to consider is that the simplest possible algorithm should be used for voice generation in order to minimize the computation time and computation complexity. In addition, the memory storage space required to store the audio files for voice generation should be as low as possible.

### SUMMARY OF THE PRESENT INVENTION

The embodiments of the present invention propose performing spoken text generation on the basis of a plurality of stored audio files which can be accessed and combined in modular fashion. The audio files comprise what are known as fixed audio files, which comprise predetermined sentence phrases or sentence components. The audio files further comprise what are known as variable audio files, which comprise spoken text that may be used to selectively supplement fixed audio files in a modular fashion.

The present invention therefore permits a large number of voice configurations or sentence configurations, arising for a voice output device, to be produced easily but effectively. In certain embodiments, the large number of voice configurations requires relatively low memory storage space. The fixed audio files may have variable positions designating locations into which the variable audio files can be “inserted” for selectively supplementing the fixed audio files. These variable positions may be at the start of and/or at the end of and/or at another location within a fixed audio file. Depending on the variable position, the variable audio File to be inserted is provided in front of or after or within the fixed audio file. This can be done by interrupting the reproduction of the fixed audio file at the location of the variable position while the variable audio file to be inserted is reproduced. Naturally, a fixed audio file may comprise more than one variable position.

Within the context of the present invention, numbers may be compiled from a plurality of variable audio files. To this end, by way of example, numerical terms are audibly produced by providing a variable audio file for each number from zero to 99 and providing a respective variable audio file for each hundred, thousand etc. Any desired number can be compiled from these variable audio files without any impairment of the intonation or the natural flow of speech. Furthermore, suitable additional files may be provided for connection of the numerical variable audio files, such as “and”.

Other embodiments of the present invention also comprise a computer program with program code which is suitable for carrying out a method in accordance with the invention when a computer program is executed on a suitable computation device, for example a voice output device with a computation unit. The computer program may be stored in the form of what is known as embedded software on a voice output device, but it may also be loaded onto the voice output device from a suitable medium via a suitable interface.

Advantages and refinements of the invention can be found in the detailed description and in the accompanying drawings.

It goes without saying that the features cited above and the features which are yet to be explained below can be used not only in the respectively indicated combination but also in other combinations or on their own without departing from the scope of the present invention.

### BRIEF DESCRIPTION OF THE DRAWINGS

The present invention is shown schematically in the drawings in the form of an exemplary embodiment which is described in detail below with reference to the drawings.

FIG. 1 shows a schematic perspective view of an exemplary embodiment of a voice output device in accordance with the present invention.

FIG. 2 shows a block diagram showing the design of the voice output device in FIG. 1.

### DETAILED DESCRIPTION OF EMBODIMENTS OF THE PRESENT INVENTION

The following description of the preferred embodiments is merely exemplary in nature and is in no way intended to limit the present invention or its application or uses.

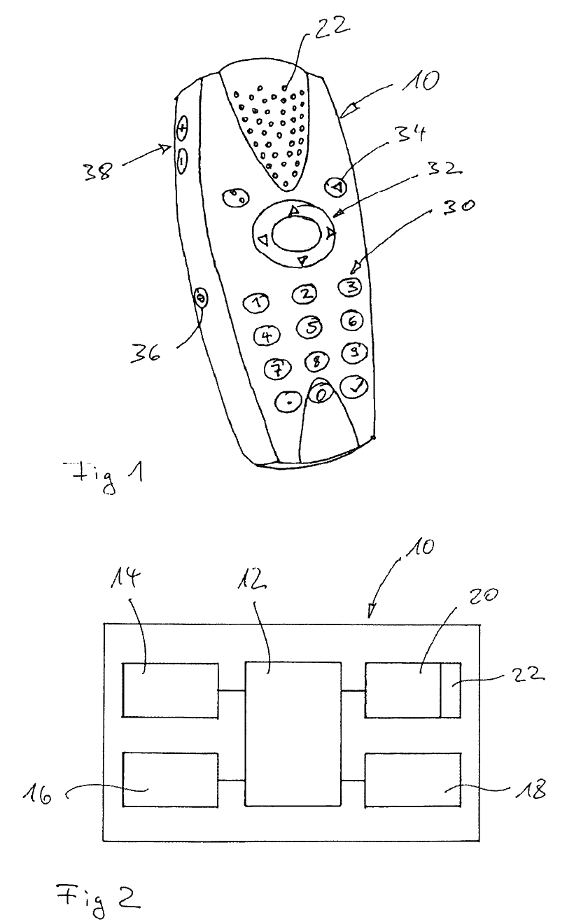

An embodiment of a voice output device 10 based on the present invention is shown in a perspective illustration in FIG. 1 and in a schematic block diagram in FIG. 2.

In one embodiment, the voice output device 10 comprises a computation unit 12, a first memory unit 14, an input unit 18 and an output unit 20 with an audio data output interface 22. The audio data output interface 22 can be a loudspeaker (see, e.g., FIG. 1) and/or a headphone or earphone jack, for example.

In other embodiments, the voice output device 10 further comprises a plurality of keys (which are not denoted in more detail and form part of the input unit 18) which an operator can use to operate and use the voice output device 10. The keys are, in one embodiment, a numerical keypad 30 (arranged as in the case of a telephone in the exemplary embodiment shown) and also control keys 32 (arrow keys), an input confirmation key 34, an on/off key 36, +/− keys 38 for volume adjustment, inter alia. The form of the input unit and particularly the type and scope of the keypad are not limited to the embodiment shown, and a person skilled in the art will appreciate from this disclosure other suitable designs of keypad arrangements.

In yet other embodiments, the input unit also comprises interfaces (not shown) for data input, such as an infrared interface, a serial data interface and/or a USB interface. Alternatively, a Bluetooth interface or the like may also be provided, for example.

According to the embodiments of the present invention, the first memory unit 14 stores audio files from which it is possible to produce the voice output from the voice output device. The audio files generally comprise fixed audio files and variable audio files. Within the context of this disclosure, fixed audio files are to be understood to mean audio files each which comprise a predetermined sentence component or in other words a fixed, invariable sentence body or base. This is typically a complete or almost complete sentence which the voice output device 10 needs to output in a given situation. If it is a complete sentence, the relevant audio file is simply reproduced via the output unit 20 in the given case. If it is an incomplete sentence, it is necessary to supplement this sentence component before or during reproduction. In accordance with the present invention, this supplementation is made using a variable audio file. Within the context of this disclosure, a variable audio file is to be understood to mean an audio file which contains individual words or short sentence fragments which can be selectively combined in modular fashion with one or more other variable audio files and/or one or more fixed audio files.

By way of example, in a given situation there could be a voice output which tells the user that he has pressed an incorrect key or has not pressed a particular key correctly. Assuming that the user has not pressed the confirmation key (bottom right in the illustration in FIG. 1) correctly, the voice output in such a case will be: “You have not pressed the confirmation key correctly”. To prevent a fixed audio file with a complete sentence from having to be spoken and stored for every possible key, the invention involves just the sentence body “You have not pressed the . . . correctly” being stored. The missing sentence component “confirmation key” is saved as a variable audio file.

In the example described, the gap in the sentence (textually represented herein by an ellipse) between the two sentence parts “not pressed the” and “correctly” is a variable position. This variable position designates a location for a relevant variable audio file, and in this example the variable position is assigned the relevant variable audio file “confirmation key” by the computation unit when the described sentence “You have not pressed the confirmation key correctly” is desired to be output. The fixed audio file in this example is therefore a fixed audio file with one variable position. For the confirmation key and any other key, there is a respective variable audio file, which means that this set of audio files can be used to produce a suitable voice output if any key is not pressed correctly.

As another example, another fixed audio file might be: “Please press . . . ”. In the case of this fixed audio file, the variable position is located at the end and can have the key names added to it by one of the variable audio files which already exist.

When the fixed audio file is output or reproduced, the relevant variable audio file is simply placed in front of or after the fixed audio file according to the location of the variable position. In the latter example, the variable audio file would be placed after it. If the user is to be asked to press the confirmation key, for example, then the fixed audio file “Please press . . . ” would first be played back, followed directly by the variable audio file “confirmation key”. In the first example described above, in which the variable position is within the fixed audio file, play-back of the fixed audio file “You have not pressed . . . correctly” is interrupted or stopped when the variable position is reached, and the variable audio File to be inserted “confirmation key” is played back followed by continued play-back of the remainder of the fixed audio file.

In the same way, the embodiments of the present invention allow numerical words to be produced using variable audio files which can be combined in modular fashion. To produce numerical words in German language, this involves storing a set of variable audio files which respectively contain one of the numbers zero to 99 in spoken language. (In English language, less files namely for the numbers zero to 20, and 30, 40, 50, 60, 70, 80 and 90, are necessary due to the different structure of numbers in this language.) To produce higher numbers, a variable audio file is created for each hundred (100, 200, 300, . . . , 900), each thousand (1000, 2000, 3000, . . . , 9000) etc. To portray the numerical value exactly in speech, it is also possible to store suitable additional variable audio files, such as “and”.

Thus, in embodiments in which at most four-digit numerical values need to be output in speech, just 118 files can be used to produce all numerical values between zero and 9999 without the need for complex algorithms or voice generation modules. At the same time, very little memory storage space is required, because consistently short voice or audio files are involved. It is also possible for year numbers to be produced from these files. Thus, the number 1963 can be produced either as a combination of the files “one thousand”, “nine hundred”, “and” and “sixty-three” or as a combination of the files “nineteen” and “sixty-three”.

The combinations which are necessary and possibly appropriate according to the configuration or context (such as in the case of year numbers) are calculated by the computation unit using saved matrices, which likewise require little memory space. Since simple calculations are involved, a high level of computation capacity is not required either.

Data or data records which are to be output can be input via the input unit directly or can be saved in an optional second memory unit 16. If the voice output device is a voice output device configured for the medical field, for example, then the data are collected as measured data and are stored in the second memory unit 16 of the voice output device using means such as an interface (for example infrared interface) and are accessed from the second memory unit 16 by the computation unit as needed and it appropriate are combined with fixed audio files from the first memory unit.

### Example

For a voice output comprising “Your insulin value on 12 Oct. 2006, at 12:08, is 104” can be produced using an embodiment of the present invention as follows:
1. fixed audio file (for the recurring sentence body): “Your insulin value on [variable position: date] [variable position: time] is [variable position: insulin value]”
2. variable audio files for date: “twelfth”+“October”+“two thousand”+“and”+“six”
3. variable audio files for time: “twelve”+“o”+“eight”
4. variable audio files for insulin value: “one”+“hundred”+“and”+“four”.

The embodiments of the present invention described in detail above allow little involvement in terms of computation capacity and memory space to be used to produce a voice output with natural clause position and intonation. This significantly improves the comprehensibility of voice output, which is extremely important, particularly in the field of voice output for medical data, in order to preclude or reduce the risk of misunderstandings and misinterpretations. In accordance with the present invention, the memory requirement is reduced as far as possible through clever combination of phrases (sentence bodies) and the use of variables at appropriate locations, without this resulting in reductions in intonation and corresponding grammatical peculiarities (even in different languages).

The features disclosed in the above description, the claims and the drawings may be important both individually and in any combination with one another for implementing the present invention in its various embodiments.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present invention in detail and by reference to specific embodiments thereof, it will be apparent that modification and variations are possible without departing from the scope of the present invention defined in the appended claims. More specifically, although some aspects of the present invention are identified herein as preferred or particularly advantageous, it is contemplated that the present invention is not necessarily limited to these preferred aspects of the present invention.

What is claimed is:

1. A voice output device having a first memory unit with capacity to store a plurality of audio files, a computation unit configured to associate one or more of the audio files being stored in the first memory unit in a correct order with one or more data records to be audibly output, and an output unit having an audio data output interface configured to reproduce the audio files in the order prescribed by the computation unit, wherein the audio files comprise fixed audio files comprising predetermined sentence components, and variable audio files for selectively supplementing the predetermined sentence components in order to produce modularly complete sentences.

2. The voice output device of claim 1, wherein the variable audio files comprise a plurality of numerical words configured to be selectively combined in modular fashion in order to produce complete numerical words.

3. A voice output device having a first memory unit with capacity to store a plurality of audio files, a computation unit configured to associate one or more of the audio files being stored in the first memory unit in a correct order with one or more data records to be audibly output, and an output unit having an audio data output interface configured to reproduce the audio files in the order prescribed by the computation unit, wherein the audio files comprise variable audio files which can be selectively combined in modular fashion in order to produce numerical words.

4. The voice output device according to claim 3, the audio files further comprising fixed audio files selectively supplemented the variable audio files.

5. The voice output device according to claim 1, wherein at least one fixed audio file further comprises at least one variable position designating a location for reproducing at least one of the variable audio files.

6. The voice output device according to claim 5, wherein the variable position of the fixed audio file is located at one or more of the start of, the end of, and within the fixed audio file.

7. The voice output device according to claim 6, wherein reproduction of audio files comprises the variable audio file being placed in front of, after, or within the fixed audio file in accordance with the location of the variable position.

8. Voice output device according to claim 5, wherein reproduction of the fixed audio file is configured to be interrupted at the variable position while the variable audio file is reproduced.

9. The voice output device according to claim 2, wherein the variable audio files are configured such that a variable audio file is provided for each number from zero to 99 and such that a respective variable audio file is provided for each hundred and each thousand.

10. A method for spoken text generation for a voice output device, comprising the steps of:
generating a plurality of audio files, the audio files comprising a plurality of fixed audio files each comprising a predetermined sentence component, the audio files furthering comprising a plurality of variable audio files each comprising one of a word and a sentence fragment selectively combinable in modular fashion with at least one of another variable audio file or a fixed audio file;
storing the audio files in a first memory unit;
associating at least one of the audio files from at least one of the fixed audio files in accordance with at least one data record desired to be audibly output;
prescribing a correct order for the audio files associated with the at least one data record; and
producing an audible output from the associated audio files.

11. The method of claim 10, wherein the variable audio files comprise a plurality of numerical words configured to be selectively combined in modular fashion in order to produce complete numerical words.

12. The method according to claim 10, wherein at least one fixed audio file comprises at least one variable position designating a location for reproducing at least one of the variable audio files.

13. The method according to claim 12, wherein the variable position of the fixed audio file is located at one or more of the start of the end of, and within the fixed audio file.

14. The method according to claim 13, wherein the variable audio file is placed in front of, after, or within the fixed audio file upon production of the audible output, in accordance with the location of the variable position.

15. The method according to claim 12, further comprising interrupting the producing of the audible output for the fixed audio file at the variable position and producing an audible output for the variable audio file at the variable position.

16. The method according to claim 10, wherein the plurality of audio files comprise one or more of words, sentence phrases, digits, and numbers.

17. The method according to claim 11, wherein the variable audio files are configured such that a variable audio file is provided for each number from zero to 99 and such that a respective variable audio file is provided for each hundred and thousand.

18. A computer program comprising programming code configured for performing the method according to claims 10 when the computer program is provided and executed on a computation device.

19. The computer program according to claim 18, wherein the program is stored on the computation device in a computer-readable medium.
